(19) United States
(12) Patent Application Publication
(10) Pub. No.: US 2021/0117831 A1
(43) Pub. Date: Apr. 22, 2021

(54) Computer System

(71) Applicant: Hitachi, Ltd., Tokyo (JP)

(72) Inventors: Yuyao WANG, Tokyo (JP); Masayoshi MASE, Tokyo (JP); Masashi EGI, Tokyo (JP)

(21) Appl. No.: 17/071,482

(22) Filed: Oct. 15, 2020

(30) Foreign Application Priority Data
Oct. 17, 2019 (JP) 2019-190398

(51) Int. Cl. G06N 5/04; G06N 20/00

(52) U.S. Cl. CPC G06N 5/045; G06N 20/00

(57) ABSTRACT

To more appropriately explain bases of estimation in a machine learning model that estimates appropriate outputs as responses to a temporally changing state. A machine learning model estimates an appropriate output in an environment with a temporally changing state. One or more processors acquire an episode. The episode includes steps at different times. Each step in the steps indicates a state of the environment, and an output selected by the machine learning model in the state. The one or more processors form a plurality of phases including one or more consecutive steps on a basis of one or more changing indicators in the episode, and generate data that explains a basis of the machine learning model in the plurality of phases.

### CLAIM OF PRIORITY

The present application claims priority from Japanese patent application JP 2019-190398 filed on Oct. 17, 2019, the content of which is hereby incorporated by reference into this application.

### BACKGROUND

The present disclosure relates to a computer system.

The background art of the present disclosure includes one that is disclosed in Japanese Unexamined Patent Application Publication No. 2017-072882, for example. Japanese Unexamined Patent Application Publication No. 2017-072882 discloses the following technology: “An information processing device 10 performs clustering of state information indicating the state of a management-target system 1 for each of a plurality of unit periods that are consecutive in time series in accordance with a predetermined condition. Next, the information processing device 10 sets each of the plurality of clusters generated by the clustering to an original state before a transition, and a resultant state after a transition. Furthermore, on the basis of temporal changes of a cluster to which the state information about each of the plurality of unit periods belongs, the information processing device 10 generates a transition probability matrix 2 for each pair of an original state before a transition, and a resultant state after the transition indicating the transition probability of the state of the system 1 from the original state to the resultant state. Then, on the basis of the transition probability matrices 2, the information processing device 10 determines whether or not the transition of the state of the system 1 from a state indicated by the state information about a first unit period in the plurality of unit periods to a state indicated by the state information about a second unit period later than the first unit period is an anomaly” (see the abstract, for example).

Machine learning models have made significant progress, and are applied to various fields as in the example described above. On the other hand, machine learning models are black boxes, and bases of results from inputs to the machine learning models are unknown. Accordingly, there is growing demand for the interpretability of machine learning models. The interpretability of machine learning models allows for: efficient improvement of the machine learning models; enhancement of the reliability of estimation results of the machine learning models; more appropriate decision-making by humans through cooperation with the machine learning models; and the like.

### SUMMARY

Although there have been several proposed methods for interpreting bases of estimation output by a machine learning model (hereinafter, also called bases of the machine learning model), there are no known methods that allow for appropriate interpretation and explanation of a basis of estimation at each time of a machine learning model that receives time-series data as inputs.

According to one aspect of the present disclosure, a computer system that generates an explanation of a basis of a machine learning model includes: one or more processors; and one or more storage devices that store a program to be executed by the one or more processors. The machine learning model estimates an appropriate output in an environment with a changing state, and the one or more processors acquire an episode, the episode including steps at different times, each step in the steps indicating a state of the environment, and an output selected by the machine learning model in the state; form multiple phases including one or more consecutive stepson a basis of one or more changing indicators in the episode; and generate data that explains a basis of the machine learning model in the multiple phases.

According to one aspect of the present disclosure, it is possible to more appropriately explain bases of estimation in a machine learning model that estimates appropriate outputs as responses to a changing state. Problems, configurations, and effects other than those mentioned before will become apparent through the following explanation of embodiments.

### BRIEF DESCRIPTION OF THE DRAWINGS

FIG. 1 is a figure illustrating a hardware configuration example of a computer system.

FIG. 2 is a figure illustrating a software configuration example of the computer system.

FIG. 3 schematically illustrates operation of a policy model, and an environment model.

FIG. 4 illustrates a configuration example of an episode database.

FIG. 5 is a figure illustrating one example of operation performed between program modules in the computer system.

FIG. 6 illustrates a configuration example of a baseline selection table.

FIG. 7 illustrates a flowchart of a process for one episode performed by an explanation generating server.

FIG. 8 illustrates a flowchart of details of a baseline selection table creation step in the flowchart illustrated in FIG. 7.

FIG. 9 illustrates a flowchart of details of a clustering step in the flowchart illustrated in FIG. 7.

FIG. 10 schematically illustrates a crane in a crane simulation.

FIG. 11 illustrates an example of temporal changes of some of inputs to, and outputs from the policy model.

FIG. 12 illustrates a configuration example of an episode table in crane control.

FIG. 13 illustrates an example of a GUI image for inputting user data.

FIG. 14 illustrates an example of user input data in an example of crane control.

FIG. 15 illustrates an example of a baseline selection table in the example of crane control.

FIG. 16 illustrates an example in which a plurality of phases are formed in an episode in accordance with the baseline selection table illustrated in FIG. 15.

FIG. 17 illustrates an example of an explanatory image generated from explanatory data.

FIG. 18 illustrates one frame image of a saliency video generated from explanatory data.

FIG. 19 schematically illustrates a configuration example of a system that controls a factory, and items to be supplied to the factory.

FIG. 20 illustrates an example of user input data in an example of item supply-order control.

FIG. 21 illustrates an example of a baseline selection table in the example of item supply-order control.

FIG. 22 illustrates an example in which a plurality of phases are formed in an episode in accordance with the baseline selection table illustrated in FIG. 21.

### DETAILED DESCRIPTION

In the following, embodiments of the present invention are explained by using the drawings. It should be noted however that the present invention should not be interpreted as being limited to description contents of the embodiments illustrated below. It is easily understood by those skilled in the art that the specific configuration of the present invention may be modified within the scope not deviating from the idea and gist of the present invention. In the configuration of the invention explained below, identical or similar configurations or functions are given identical reference characters, and overlapping explanation is omitted. Positions, sizes, shapes, areas, and the like of configurations illustrated in the drawings, and the like do not represent actual positions, sizes, shape, areas, and the like in some cases, for facilitating the understanding of the invention. Accordingly, the present invention is not limited to positions, sizes, shapes, areas, and the like that are disclosed in the drawings, and the like.

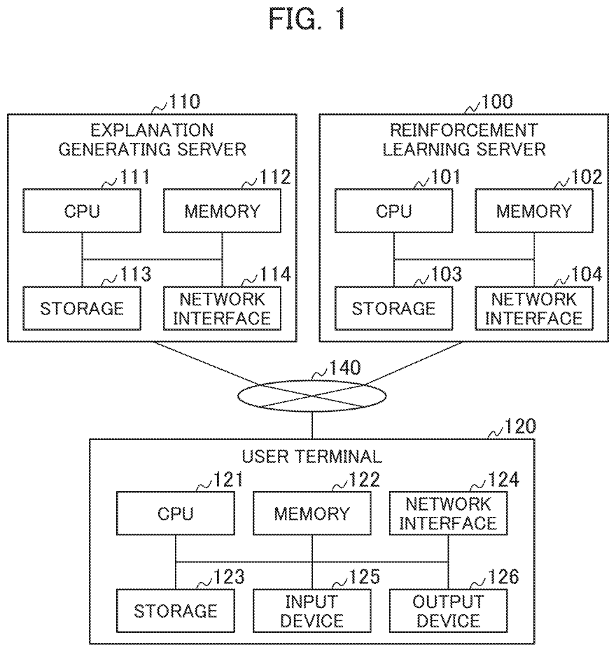

FIG. 1 is a figure illustrating a hardware configuration example of a computer system. The computer system illustrated in FIG. 1 includes a reinforcement learning server 100, an explanation generating server 110, and a user terminal 120. Each device is connected with each other via a network 140. Note that the network 140 may be any type of network, and for example is a WAN (Wide Area Network), a LAN (Local Area Network), and the like. In addition, the method of connection by the network 140 may be any of a wireless connection method and a wired connection method.

The reinforcement learning server 100 stores a policy model (an agent or reinforcement learning model) generated by reinforcement learning, and an environment model that provides an environment in which the policy model operates. The policy model is a model that has been trained by using training data. The reinforcement learning server 100 executes interactions between the policy model, and the environment model multiple times in one execution of simulation processing until a predetermined termination condition is satisfied. In the following, each execution of the simulation processing is called an episode, and each interaction between the agent, and the environment in the simulation processing is called a step.

The hardware configuration of the reinforcement learning server 100 includes a CPU 101, a memory 102, a storage 103, and a network interface 104. The hardware components communicate with each other via an internal bus. The CPU 101 executes programs stored on the memory 102. The memory 102 stores the programs executed by the CPU 101, and information necessary for the programs. In addition, the memory 102 includes a work area used temporarily by the programs.

The storage 103 stores data permanently. Possible examples of the storage 103 include a storage medium such as a HDD (Hard Disk Drive) or a SSD (Solid State Drive), a non-volatile memory, and the like. Note that the programs, and information stored on the memory 102 may be stored on the storage 103. In this case, the CPU 101 reads out the programs, and information from the storage 103, loads the programs, and information onto the memory 102, and executes the programs having been loaded onto the memory 102. The network interface 104 is connected with other devices via networks.

The explanation generating server 110 interprets a basis of estimation of the policy model (also called a basis of the policy model), and generates an explanation therefor. The hardware configuration of the explanation generating server 110 includes a CPU 111, a memory 112, a storage 113, and a network interface 114. The hardware components communicate with each other via an internal bus, or the like.

The CPU 111, memory 112, storage 113, and network interface 114 are hardware components similar to the CPU 101, memory 102, storage 103, and network interface 104.

The user terminal 120 is a terminal used by a user. The user terminal 120 receives a user input for generating an explanatory text of the policy model, and presents the explanation of a basis of estimation of the policy model to the user. The hardware configuration of the user terminal 120 includes a CPU 121, a memory 122, a storage 123, a network interface 124, an input device 125, and an output device 126. The hardware components communicate with each other via an internal bus.

The CPU 121, memory 122, storage 123, and network interface 124 are hardware components similar to the CPU 101, memory 102, storage 103, and network interface 104.

The input device 125 is a device for inputting data, and the like, and includes a keyboard, a mouse, a touch panel, and the like. The output device 126 is a device for outputting data, and the like, and includes a display, a touch panel, and the like.

In the devices described above, the CPUs execute processes in accordance with programs, and the devices thereby operate as functional sections having predetermined functions. In the following explanation, in a case that processes are explained as being executed by the programs, this represents that the CPUs or the devices in which the CPUs are implemented execute the programs that realize the functional sections.

In the configuration example illustrated in FIG. 1, different computers each execute a different task of execution of simulations, and generation of explanatory texts. In another example, one computer may execute the two tasks. For example, the reinforcement learning server 100, and the explanation generating server 110 may be realized as a virtual computer that operates on one computer.

As mentioned above, the computer system can include one or more computers including one or more processors, and one or more storage devices including non-transitory storage media. The memories, storages, or combinations thereof are the storage devices. The CPUs are an example of processors. The processors can include a single processing unit or a plurality of processing units, and can include a single calculation unit or a plurality of units, or a plurality of processing cores. The processors can be implemented as one or more central processing units, microprocessors, microcomputers, microcontrollers, digital signal processors, state machines, logic circuits, graphics processing units or chip-on systems, and/or any devices that manipulate signals on the basis of control instructions.

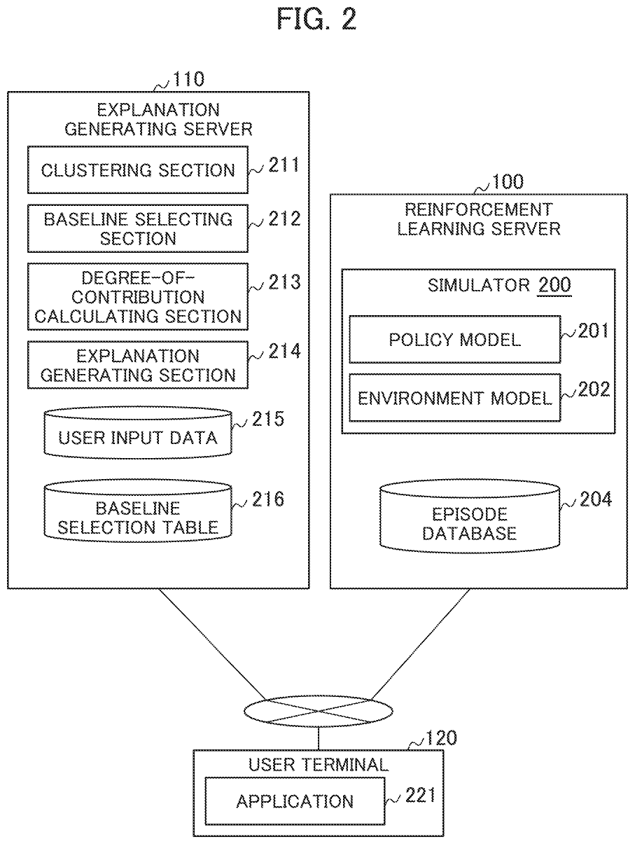

FIG. 2 is a figure illustrating a software configuration example of the computer system. The reinforcement learning server 100 stores a simulator 200, and an episode database 204. The simulator 200 is a program module stored on the memory 102, and executed by the CPU 101, and includes a policy model 201, and an environment model 202.

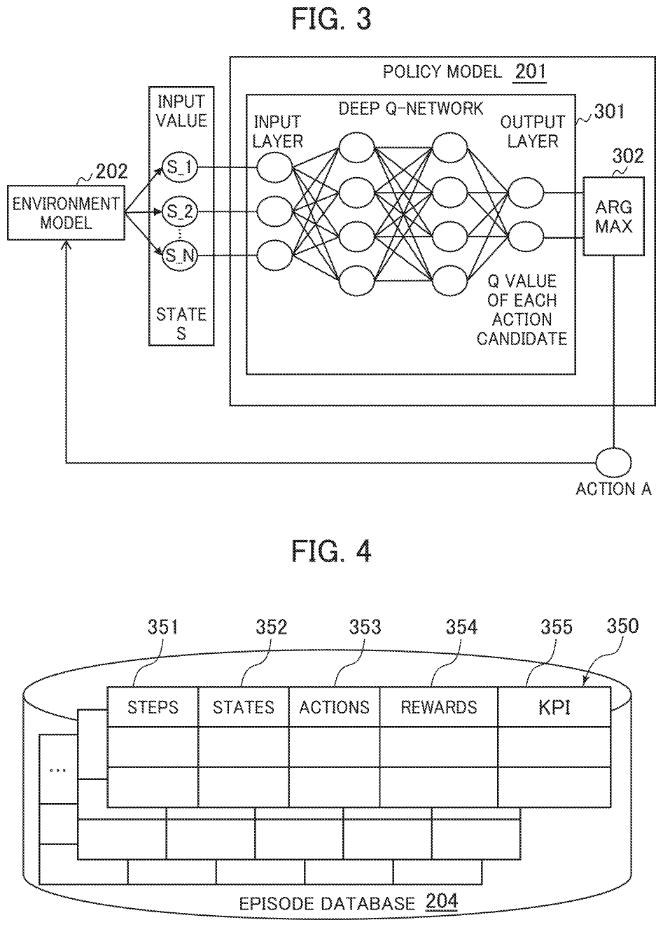

FIG. 3 schematically illustrates operation of the policy model 201, and the environment model 202. The policy model 201 functions as an agent in reinforcement learning. FIG. 3 illustrates an example of deep Q-learning. The policy model 201 includes a deep Q-network 301, and an argmax function 302. The deep Q-network 301 is a deep neural network, and includes an input layer, intermediate layers, and an output layer.

The policy model 201 acquires information about a state S of an environment output from the environment model 202, and selects an action on the basis of the acquired information, and a policy. In addition, the policy model 201 outputs information about the selected action to the environment model 202. Specifically, the policy model 201 receives, as inputs to the input layer, a plurality of features S_1 to S_N representing the state S of the environment. The value of each node on the output layer is a Q value of an action candidate. On the basis of Q values of action candidates, the argmax function 302 selects an action A to be output.

The environment model 202 functions as an environment in which the policy model 201 operates. The environment model 202 acquires information about the action output from the policy model 201, and executes a simulation of a transition of the state on the basis of the acquired information, and the current state of the environment. In addition, as results of the simulation, the environment model 202 outputs, to the policy model 201, information indicating the state of the environment after the transition.

Note that the machine-learning-model explanation method disclosed in the present specification can be applied to models of machine learning other than deep Q-networks by deep reinforcement learning, and, for example, can be applied to imitation learning models, decision trees, machine learning models whose outputs are not actions, and the like.

FIG. 4 illustrates a configuration example of the episode database 204. The episode database 204 stores results of simulations by the simulator 200. The episode database 204 includes a plurality of episode tables 350 each indicating results of execution of a simulation for one episode. The episode tables 350 are given episode sequence numbers.

An episode table 350 includes a plurality of entries including steps 351, states 352, actions 353, rewards 354, and KPIs (Key Performance Indicators) 355. The number of entries included in an episode table 350 corresponds to the number of interactions (steps) that occurred in one episode.

The fields of steps 351 store identification numbers of steps. The identification numbers set in the fields of steps 351 match the positions, in an execution order, of interactions corresponding to the entries. The fields of states 352 store values indicating the state of an environment. The fields of actions 353 store information indicating actions that are taken in the state of the environment corresponding to the states 352. The fields of rewards 354 store rewards that are given in a case that actions corresponding to the actions 353 are taken in the state of the environment corresponding to the states 352.

The group of fields of KPIs 355 stores KPIs after the actions are taken. The KPIs are indicators to be referred to for some purpose. The stored KPIs include indexes (parameters) that may be referred to for generation of explanations of bases of the policy model 201. For example, the KPIs include KPIs to be used in clustering of steps in an episode mentioned below, KPIs that may be specified by a user, KPIs that may be included in explanatory images, and the like.

In the present example, the episode database 204 stores results of simulations performed by using the environment model 202. In another example, the episode database 204 may store results of execution of the policy model 201 in an actual environment, and may store episodes of a simulation environment, and an actual environment. An episode indicates a time series of steps from a step at which a predetermined start condition is satisfied, and until a step at which a predetermined termination condition is satisfied. In addition, the simulator 200 may be omitted from the computer system.

Returning to FIG. 2, the explanation generating server 110 includes a clustering section 211, a baseline selecting section 212, a degree-of-contribution calculating section 213, and an explanation generating section 214. These are program modules that are stored on the memory 112, and executed by the CPU 111. The explanation generating server 110 further stores user input data 215, and a baseline selection table 216.

The clustering section 211 forms a plurality of clusters of steps in an episode acquired from the episode database 204. A cluster includes one or more consecutive steps. As mentioned below, one cluster includes steps in one state (phase) in the state transition of an environment. A state in an environment, and a cluster of the state are also called a phase. The baseline selecting section 212 decides a baseline for calculating a degree of contribution in each phase.

The degree-of-contribution calculating section 213 decides a degree of contribution of an input feature to an action at each step in each phase on the basis of the value of the input feature at the step, and a value (input reference data) of an input feature of the specified baseline. The degree-of-contribution calculating section 213 decides the degree of contribution of the input feature on the basis of a relative value of the input feature at the step by using the baseline value as a reference point. On the basis of the degree of contribution computed by the degree-of-contribution calculating section 213, the explanation generating section 214 generates explanatory data for explaining a basis of the policy model 201.

The degree-of-contribution calculating section 213 may compute degrees of contribution in accordance with an algorithm. For example, the degree-of-contribution calculating section 213 can use SHAP (Shapley Additive Explanation), LIME (Local Interpretable Model-Agnostic Explanations), Integrated gradient, and the like.

The user input data 215 is data input through the user terminal 120, and used by the explanation generating server 110 to generate explanations of bases of the policy model 201. The baseline selection table 216 indicates a relationship between phases, and baselines.

The user terminal 120 stores an application 221 for manipulating an interface provided by the explanation generating server 110. The application 221 is a program module, and is stored on the memory 122, and executed by the CPU 121. The user terminal 120 receives, via the input device 125, inputs of user data used by the explanation generating server 110 to explain bases of the policy model 201. The user terminal 120 outputs, on the output device 126, the explanations of the bases of the policy model 201 generated by the explanation generating server 110.

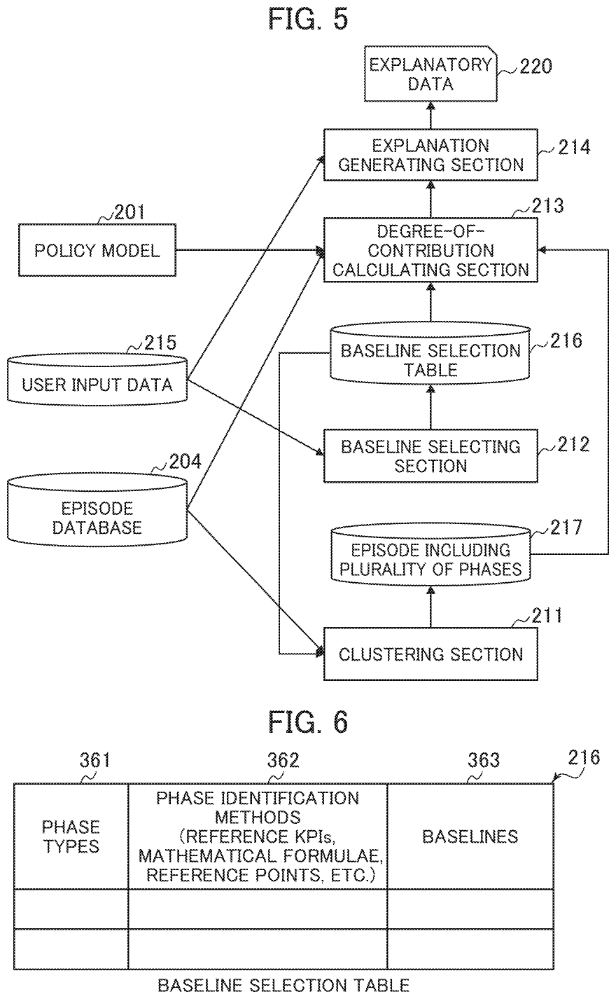

FIG. 5 is a figure illustrating one example of operation performed between program modules in the computer system. The baseline selecting section 212 generates the baseline selection table 216 on the basis of the user input data 215. The user input data 215 includes information for identifying phases in an episode. Details of the user input data 215 are mentioned below.

FIG. 6 illustrates a configuration example of the baseline selection table 216. The baseline selection table 216 includes a plurality of entries including phase types 361, phase identification methods 362, and baselines 363. The fields of phase types 361 indicate types of phase that can be applied to an episode.

The fields of phase identification methods 362 indicate methods for identifying phase types indicated by the phase types 361. The phase identification methods 362 indicate KPIs (parameters), mathematical formulae, reference values, and the like that should be referred to in order to identify phase types. Baselines 363 indicate baselines to be used in computation of degrees of contribution for phase types indicated by the phase types 361.

Returning to FIG. 5, the clustering section 211 acquires one episode from the episode database 204, and forms a plurality of phases in the episode in accordance with a method indicated by the baseline selection table 216. An episode 217 including a plurality of phases is generated. One phase includes one or more steps. The phases are separated from each other with no overlaps, even partial ones, therebetween, and one step is included only in one phase. Some steps may not be included in any of the phases.

The degree-of-contribution calculating section 213 computes degrees of contribution of input features to actions at steps in the episode 217 including the plurality of phases. The degree-of-contribution calculating section 213 selects baselines corresponding to the phases including the steps from the baseline selection table 216, and acquires values (input reference data) of input features of the baselines. On the basis of the input reference data, the degree-of-contribution calculating section 213 computes degrees of contribution of the input features to the actions at the steps.

For example, on the basis of the policy model 201, the degree-of-contribution calculating section 213 generates an explanation model for outputting degrees of contribution. The degree-of-contribution calculating section 213 computes relative values from the values of the input features of the steps, and the values of the input features of the baselines. The degree-of-contribution calculating section 213 inputs the relative values of the input features into the explanation model, and computes the degrees of contribution of the input features at the steps to the actions. Note that a common baseline may be used for all the phases, and the baselines 363 may be omitted from the baseline selection table 216.

The explanation generating section 214 acquires the episode 217 including the plurality of phases, alongside degrees of contribution computed by the degree-of-contribution calculating section 213. The explanation generating section 214 generates explanatory data 220 from the acquired data. The explanation generating section 214 may generate the explanatory data 220 further on the basis of the user input data 215.

The explanatory data 220 can include data such as sentences, graphs, still images, or moving images, for example. The explanatory data can include data such as a saliency video emphasizing features with high degrees of contribution, a state transition diagram illustrating the transition of phases, explanatory texts of degrees of contribution at phases, or a graph illustrating changes of degrees of contribution, for example.

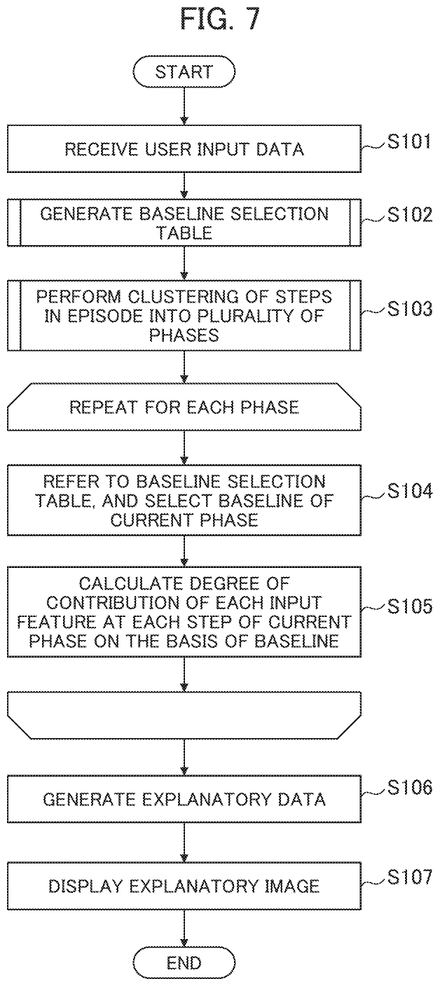

FIG. 7 illustrates a flowchart of a process for one episode performed by the explanation generating server 110. The explanation generating server 110 receives user input data 215 via the user terminal 120 (S101). Note that instead of new user input data from the user terminal 120, the explanation generating server 110 may use a file of user input data stored on a storage device in advance.

The baseline selecting section 212 generates the baseline selection table 216 on the basis of the user input data 215 (S102). The clustering section 211 performs clustering of steps in an episode acquired from the episode database 204 into a plurality of phases in accordance with the baseline selection table 216 (S103). As mentioned above, the baseline selection table 216 indicates information about phases formed in an episode.

The explanation generating server 110 executes Steps S104, and S105 for each phase in the episode. The degree-of-contribution calculating section 213 selects a baseline of a current phase by referring to the baseline selection table 216 (S104). On the basis of input reference data of the selected baseline, the degree-of-contribution calculating section 213 calculates a degree of contribution of an input feature of each step in the current phase (S105). As mentioned above, on the basis of the policy model 201, the degree-of-contribution calculating section 213 can generate an explanation model that outputs degrees of contribution, and obtain degrees of contribution by inputting relative values of input features for the input reference data to the explanation model.

The explanation generating section 214 acquires the episode 217 including the plurality of phases, alongside degrees of contribution computed by the degree-of-contribution calculating section 213. The explanation generating section 214 generates explanatory data 220 from the acquired data (S106). The explanation generating section 214 sends the explanatory data 220 to the user terminal 120, and causes the output device 126 to display an explanatory image (S107).

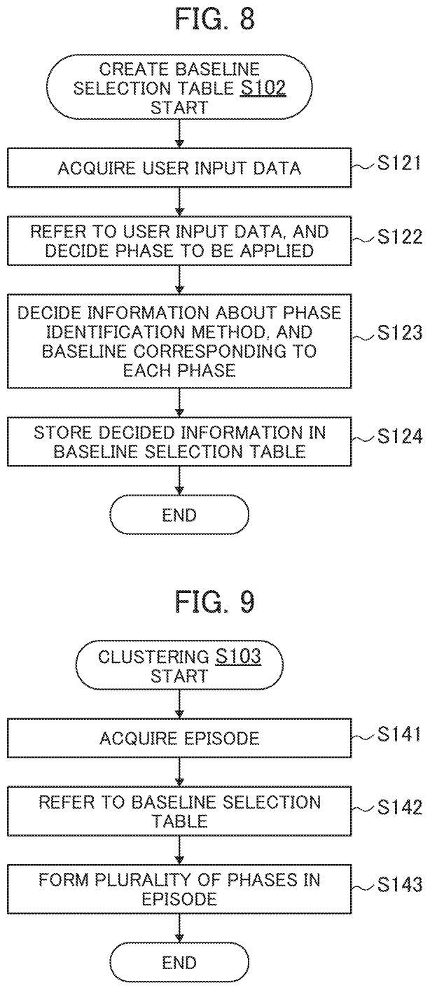

FIG. 8 illustrates a flowchart of details of the baseline selection table creation step S102 in the flowchart illustrated in FIG. 7. The baseline selecting section 212 acquires the user input data 215 (S121). The user input data 215 indicates KPIs that should be referred to for explanation of the policy model 201, for example. On the basis of information indicated by the user input data 215, the baseline selecting section 212 decides phases to be applied to the episode (S122). For example, phases to be applied to an episode are associated in advance directly or indirectly with information about KPIs indicated by the user input data 215.

The baseline selecting section 212 decides information about phase identification methods, and baselines corresponding to the selected phases (S123). Phase identification methods, and baselines are associated in advance with phases. The baseline selecting section 212 stores, in the baseline selection table 216, the decided information about the phase identification methods, and baselines (S124).

FIG. 9 illustrates a flowchart of details of the clustering step S103 in the flowchart illustrated in FIG. 7. The clustering section 211 acquires one episode from the episode database 204 (S141). The clustering section 211 refers to the baseline selection table 216 (S142).

The baseline selection table 216 indicates phase types 361 to be applied to the episode, and identification methods 362 therefor. The phase identification methods 362 indicate KPIs for clustering that serve as reference points on the basis of which phase types are identified, for example. In accordance with the phase identification methods 362, the clustering section 211 forms a plurality of phases from steps in the episode (S143).

In the example described above, the baseline selection table 216 is created by referring to the user input data 215. In another example, the baseline selection table 216 may be preset. In accordance with a preset rule indicated by the baseline selection table 216, the clustering section 211 forms a plurality of phases in the episode.

As mentioned above, it becomes possible to more appropriately explain bases of a policy model as responses to the temporally changing state of an environment by forming a plurality of phases in an episode, and deciding a baseline for each phase. Explanation that is more appropriate in terms of KPIs becomes possible by forming a plurality of phases in an episode on the basis of particular KPIs. In addition, explanation that is easier for users to understand becomes possible by deciding phase types to be applied to an episode by referring to user input data.

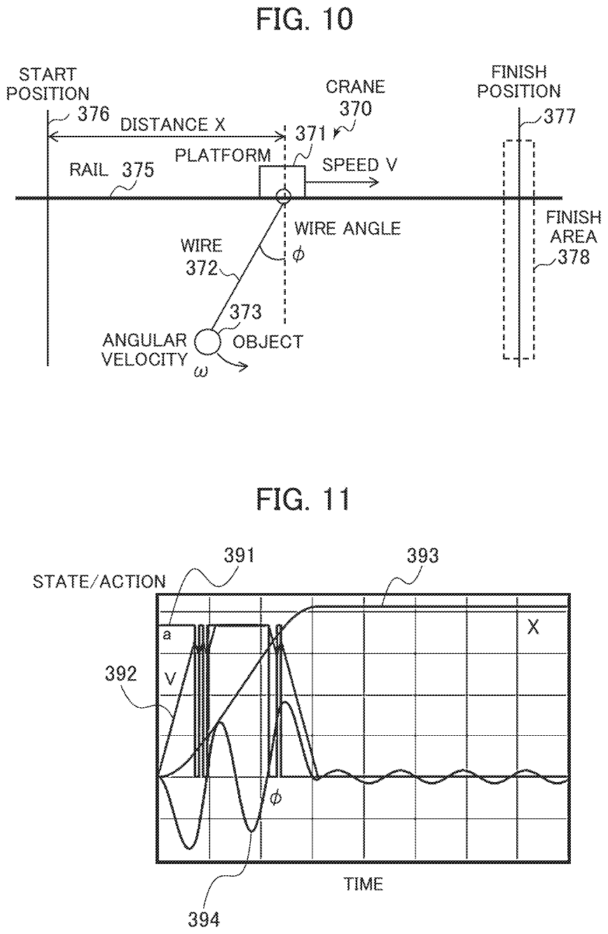

In the following, an example to which the policy-model basis explanation method according to the present specification is applied is explained. First, crane control is explained as one example of machine manipulation. FIG. 10 schematically illustrates a crane in a crane simulation. A crane 370 includes a platform 371, and a wire 372 fixed to the platform. An object 373 is fixed to the tip of the wire 372.

The crane 370 travels on a rail 375 from a start position 376 to a finish position 377, and moves the object 373. The policy model 201 controls the speed of the platform 371 for moving the object 373 from the start position 376 to the finish position 377. The policy model 201 can cause the platform 371 to travel only in the direction from the start position 376 to the finish position 377.

In addition, the policy model 201 can control only the acceleration and deceleration of the platform 371, and can accelerate or decelerate the platform 371 only at a constant rate. The platform 371 cannot travel faster than a prescribed maximum speed. When the platform 371 is travelling at the maximum speed, the speed of the platform 371 is maintained at the maximum speed if acceleration manipulation is performed, and the speed is reduced if deceleration manipulation is performed.

When the platform 371 starts travelling, the object 373 fixed to the wire 372 swings like a pendulum. The purpose of control of the platform 371 is to move the object 373 to the finish position 377 as fast as possible, and make the object 373 not swing at the time of the finish.

More specifically, the platform 371 is required to stop at a predetermined finish area 378 including the finish position 377, and to keep the amplitude of the object 373 at the time of the finish smaller than a threshold. The policy model 201 controls the acceleration (speed) of the platform 371 such that the amplitude of the object 373 at the time of the finish is minimized, the travelling time is minimized, and the difference between the finish position 377, and the final stop position is minimized.

The states of the crane 370, and the object 373 are input to the policy model 201. Specifically, the travelling distance x of the platform 371, the speed v of the platform 371, the angle φ of the wire 372, and the angular velocity ω of the object 373 are input. In accordance with the input data, the policy model 201 estimates and outputs either an accelerating action or a decelerating action as an appropriate action.

FIG. 11 illustrates an example of temporal changes of some of inputs to, and outputs from the policy model 201. In the graph illustrated in FIG. 11, a line 391 illustrates temporal changes of the output (action) of the policy model 201. The line 391 includes alternately repeating high levels, and low levels. The high levels indicate acceleration, and the low levels indicate deceleration. A line 392 illustrates temporal changes of the speed v of the platform 371. A line 393 illustrates temporal changes of the travelling distance x of the platform 371. Aline 394 illustrates temporal changes of the angle φ of the wire 372.

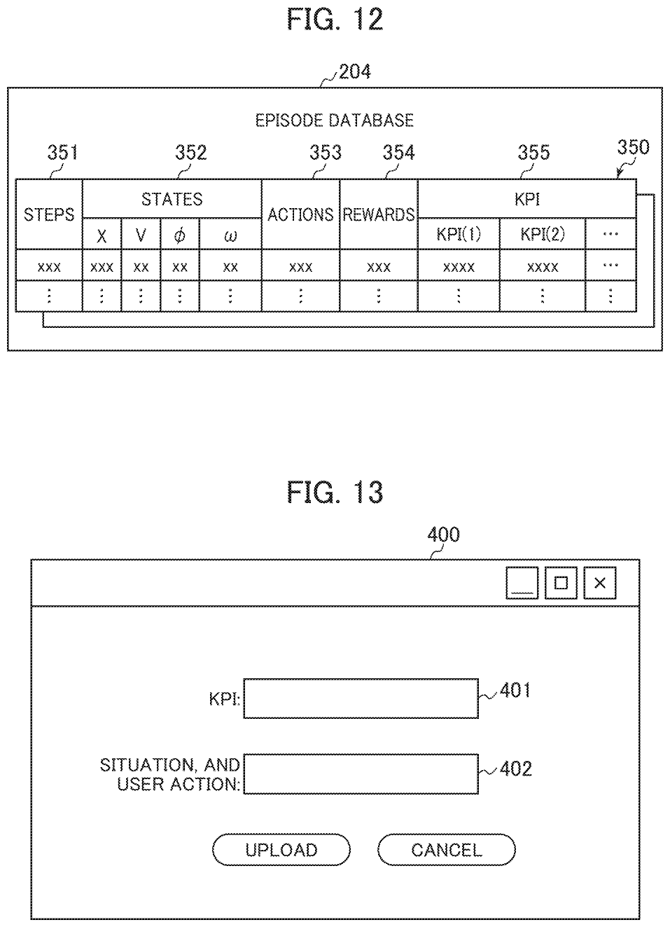

FIG. 12 illustrates a configuration example of an episode table 350 in the crane control in the present example. As mentioned above, one episode includes steps from the start of the travelling of the platform 371 from the start position 376 to the stop of the platform 371 near the finish position 377. At each step, values of the current state (feature) 352 are input to the policy model 201, and the policy model 201 outputs an action in response to the inputs.

The fields of states 352 store the travelling distance x of the platform 371, the speed v of the platform 371, the angle φ of the wire 372, and the angular velocity ω of the object 373. The fields of actions 353 indicate acceleration or deceleration. The fields of KPIs 355 indicate estimated time of arrival at the finish position 377, the angle φ of the wire 372, errors as the distance of the final stop position to the finish position 377, and the like, for example.

FIG. 13 illustrates an example of a GUI (Graphical User Interface) image 400 for receiving an input of user data. For example, the application 221 displays the image 400 on the output device 126 (display device) of the user terminal 120. A field 401 displays a selection list from which one or more KPIs are to be selected.

A field 402 is a field for receiving an input of one or more combinations of situations corresponding to the one or more selected KPIs, and user actions. For example, the application 221 displays a list of combinations of situations, and user actions, and prompts a user to select several combinations. An input of situations, and user actions may be omitted.

The computer system may apply, to a user, a GUI image for specifying a policy model 201 for which the user requests explanations. On the GUI image, the user may specify an episode for which the user requests explanations. An episode to be specified may be stored on the episode database 204 in advance, or may be newly generated by the reinforcement learning server 100. The reinforcement learning server 100 executes the simulator 200 in accordance with an instruction from the user, and generates a new episode.

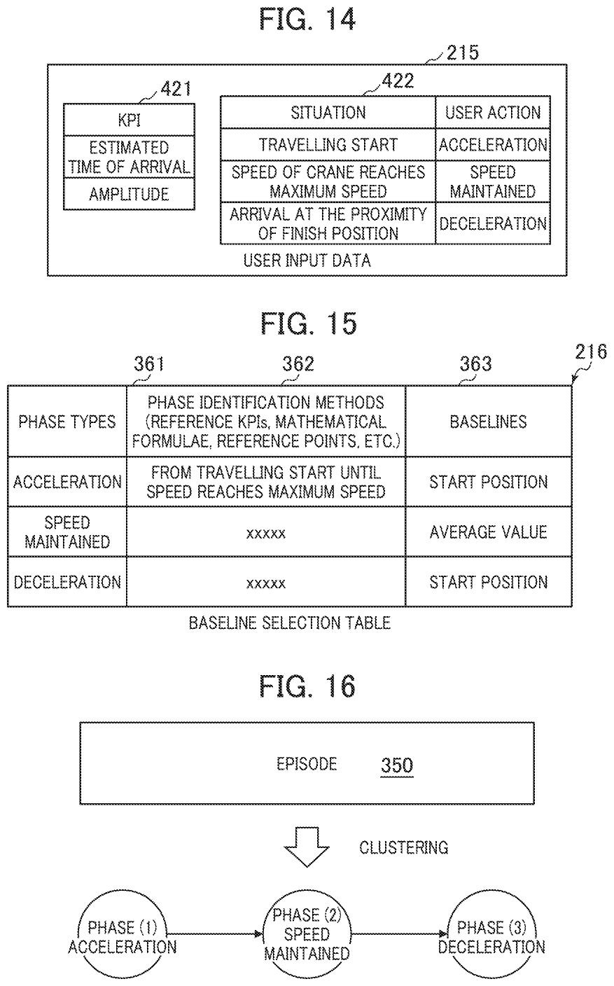

FIG. 14 illustrates an example of the user input data 215 in the example of the crane control explained with reference to FIG. 10. The user input data 215 includes a list 421 of the specified KPIs, and a list 422 of combinations of situations, and user actions. In the example illustrated in FIG. 14, the KPIs are estimated time of arrival of the platform 371, and the swing angle of the wire 372. In addition, three combinations of situations, and actions are illustrated.

FIG. 15 illustrates an example of the baseline selection table 216 in the example of the crane control explained with reference to FIG. 10. The baseline selecting section 212 generates the baseline selection table 216 on the basis of the user input data 215. For example, from predefined phases, the baseline selecting section 212 selects phases associated in advance with combinations of situations, and user actions. Alternatively, the baseline selection table 216 may be associated in advance with user-input KPIs, and an input of situations, and actions may be omitted.

In the example illustrated in FIG. 15, the fields of phase types 361 indicate three phases, which are the phase of acceleration, the phase of maintained speed, and the phase of deceleration. These are associated with: a combination of the start of travelling, and acceleration; a combination of reaching the maximum speed of the crane, and maintained speed; and a combination of arrival at the proximity of the finish position, and deceleration, respectively.

The fields of phase identification methods 362 indicate methods for identifying the three phases described above in an episode. The phase identification methods are associated in advance with the phases indicated by the fields of phase types 361. The fields of baselines 363 indicate baselines of the three phases described above. The baselines are associated in advance with the phases indicated by the fields of phase types 361.

The baselines of the phase of acceleration, and the phase of deceleration are the start position. A value input to the policy model 201 at the start position is used as a reference point for degree-of-contribution calculation. The baseline of the phase of maintained speed is an average value. The average value of values input to the policy model 201 in an episode are used as a reference point for degree-of-contribution calculation.

In accordance with the baseline selection table 216, the clustering section 211 forms a plurality of phases in the episode. In accordance with a method indicated by the phase identification methods 362, the clustering section 211 decides phases in the episode. In the present example, as illustrated in FIG. 16, the episode is divided into the phase of acceleration (phase (1)), the phase of maintained speed (phase (2)), and the phase of deceleration (phase (3)). The phase of maintained speed (phase (2)) follows the phase of acceleration (phase (1)), and the phase of deceleration (phase (3)) follows the phase of maintained speed (phase (2)).

In the present example, the clustering section 211 decides the phases on the basis of the speed of the platform 371. The speed of the platform 371 is a KPI for forming the phases in an episode. A KPI for clustering is indicated in the fields of phase identification methods 362, and, as mentioned above, is derived from user-specified KPIs. Although the user-specified KPIs, and the KPI for clustering are different in the present example, they match in some cases.

The degree-of-contribution calculating section 213 acquires, from an episode, input reference data of corresponding baselines for each of the three phases indicated by the baseline selection table 216, and calculates the degree of contribution of each input feature (state element) at each step. On the basis of the degree of contribution of each phase in the episode, the explanation generating section 214 generates explanatory data 220 of the policy model 201.

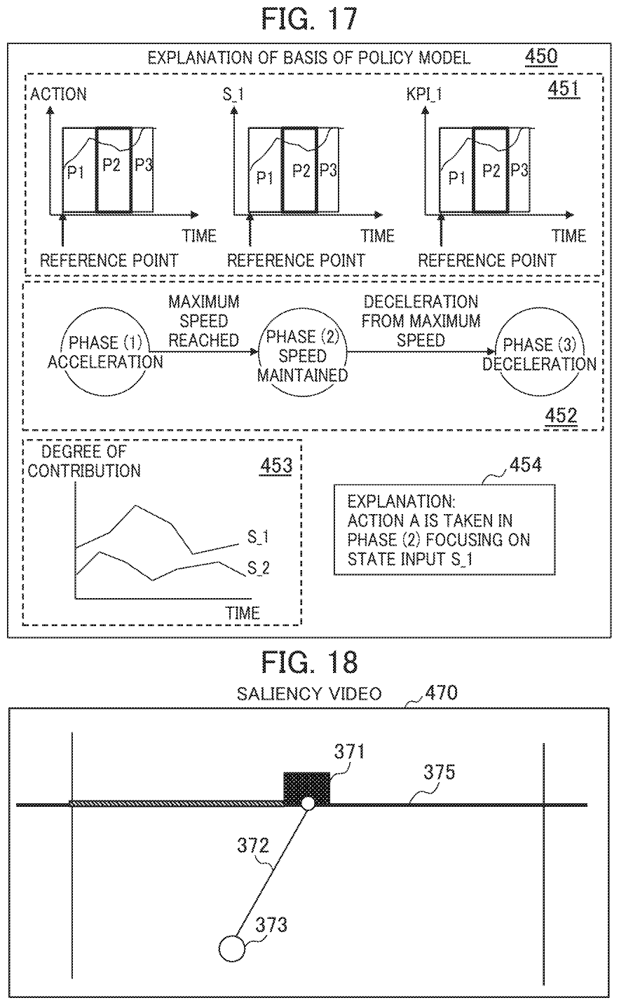

FIG. 17 illustrates an example 450 of an explanatory image generated from the explanatory data 220. The explanatory image 450 includes a plurality of sections indicating different types of explanatory image. By displaying multiple types of explanatory image, it is possible to deepen the understanding by users. Note that some of sections explained below may be omitted.

A section 451 illustrates a graph of temporal changes of actions, a graph of temporal changes of a particular input feature (an element of the state), and a graph of temporal changes of a particular KPI. The particular KPI is, for example, a KPI specified by a user on the GUI image 400, or a KPI used in clustering. Phases are indicated by rectangles in the graphs. The graphs in the section 451 are schematic diagrams, and do not match the graph illustrated in FIG. 11. With these graphs, it is possible to make users easily recognize temporal changes of the environment in which the policy model 201 operates, and actions as responses to the temporal changes.

A section 452 illustrates a state transition diagram illustrating phase changes. The section 452 illustrates a plurality of phases, the order of the phases, and information about the triggers for the phase changes. The illustrated phases correspond to phases determined by the clustering of the episode by the clustering section 211. The triggers for the phase transitions are preset for combinations of phases before and after the transitions, for example. With the state transition diagram illustrating phase transitions, it is possible to make users easily recognize phases to serve as reference points for explanations.

A section 453 illustrates a graph of temporal changes of degrees of contribution of input features. FIG. 17 schematically illustrates temporal changes of degrees of contribution of two input features (state elements) S_1 and S_2. Thereby, it is possible to make users easily recognize a relationship between temporal changes of degrees of contribution, and the degrees of contribution.

A section 454 illustrates an explanatory text of a basis of the policy model 201. The section 454 explains a basis of the policy model 201 at a specified step, for example. A step is specified by placing a pointer on a particular point on the graph of the temporal changes of actions in the section 451, for example. The explanatory text explains a reason why an action is selected, in terms of degrees of contribution, for example. The explanatory text presents information about an input feature having a high degree of contribution, and information about a phase, for example. With the explanatory text, it is possible to make users understand reasons for actions of the policy model 201 more easily.

FIG. 18 illustrates one frame image 470 of a saliency video generated from the explanatory data 220. The saliency video is an example of an image (moving image) for explaining a basis of the policy model. The saliency video represents the motion of the travelling platform 371, and the object 373. The saliency video emphasizes a part of an image on the display such that an input feature having a high degree of contribution at a particular moment is indicated thereby. In the image 470 illustrated in FIG. 18, the platform 371, and (a part of) the rail 375 are emphasized on the display.

In the example illustrated in FIG. 18, the platform 371 is associated with the speed v, and the rail 375 is associated with the travelling distance x. In addition, for example, the wire 372 is associated with the wire angle φ, and the object 373 is associated with the object angular velocity ω. The image 470 illustrated in FIG. 18 illustrates that the degrees of contribution of the speed, and travelling distance of the platform 371 to a decision about an action by the policy model 201 at this moment are high. For example, in a case that a degree of contribution exceeds a predetermined threshold, an image element corresponding to the degree of contribution is emphasized on the display.

With the saliency video, it is possible to make users intuitively, and easily recognize elements that are contributing significantly to an action of the policy model 201. The saliency video may be displayed simultaneously with the image 450 illustrated in FIG. 17. In addition, only one of the image 450 illustrated in FIG. 17, and the saliency video may be provided. The explanatory images illustrated in FIG. 17, and FIG. 18 are one example, and the computer system may generate an image for explaining a basis of the policy model 201 in any other manner.

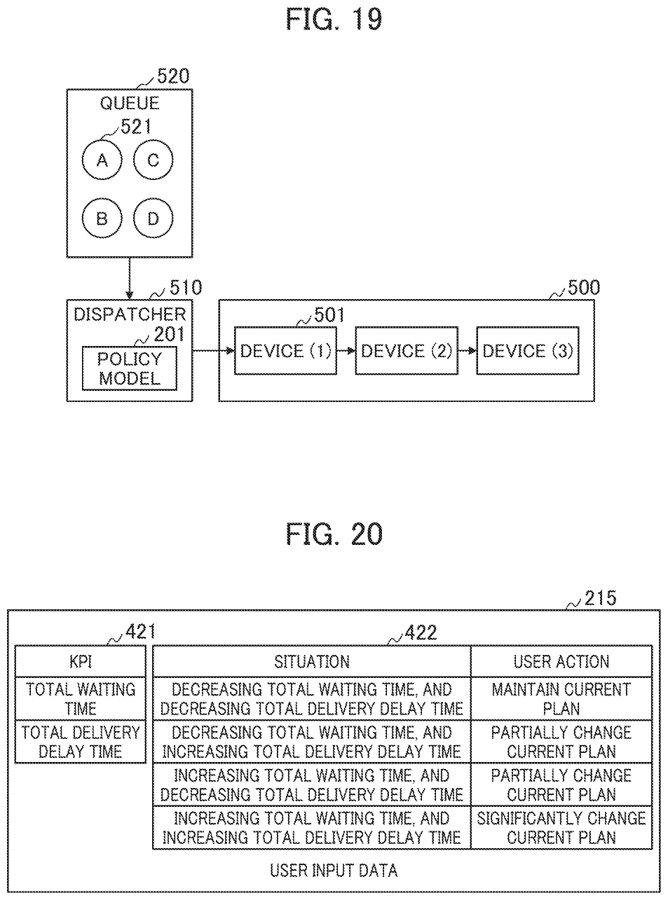

Next, an example in which the order of items to be supplied to a factory including a plurality of devices is controlled is explained. FIG. 19 schematically illustrates a configuration example of a system that controls the factory, and items to be supplied to the factory. In accordance with outputs of the policy model 201, a dispatcher 510 selects, from a queue 520, items 521 to be supplied to a factory 500 having a plurality of devices 501. The selection of the items 521 from the queue 520 is an action output by the policy model 201. The states of the device 501, items 521, and factory 500, and the like are defined as an environment, and simulated by the environment model 202.

In the system illustrated in FIG. 19, state data to be acquired for each device 501 includes: supply time; the type of a supplied item 521; the temperature of the item 521; the state of the device 501; waiting time until the supply of a next item 521 to the device 501; and the like. In addition, each item 521 is given attribute information such as delivery date/time, or type. Possible KPIs include: KPIs for individual items 521 such as processing time required for processes of the items 521, or time left until delivery dates/times; and KPIs of the whole system such as the average processing time, or the rate of on-time delivery.

FIG. 20 illustrates an example of the user input data 215 in the example of the item supply-order control explained with reference to FIG. 19. As mentioned above, the user input data 215 is acquired via the GUI image 400 illustrated in FIG. 13, or from a file stored in advance. The user input data 215 includes the list 421 of the specified KPIs, and the list 422 of combinations of situations, and user actions.

In the example illustrated in FIG. 20, KPIs are the total waiting time of items in the factory 500, and the total delivery delay time of the items in the factory 500. The waiting time of one item is the sum of waiting time that has elapsed in a device 501 from the supply of the item to the factory 500 until the current time. The total waiting time is the sum of the waiting time of all the items that are present in the factory 500. The delivery delay time of one item is the time that has elapsed from the delivery date/time of the item. In a case that the current time is before the delivery date/time, the delivery delay time is zero. The total delivery delay time is the sum of the delivery delay time of all the items that are present in the factory 500.

The user input data 215 indicates four combinations of situations, and actions. In a situation where the total waiting time is decreasing, and the total delivery delay time is decreasing, the user action is to maintain the current plan. In a situation where the total waiting time is decreasing, and the total delivery delay time is increasing, the user action is to partially change the current plan. Ina situation where the total waiting time is increasing, and the total delivery delay time is decreasing, the user action is to partially change the current plan. Ina situation where the total waiting time is increasing, and the total delivery delay time is increasing, the user action is to significantly change the current plan.

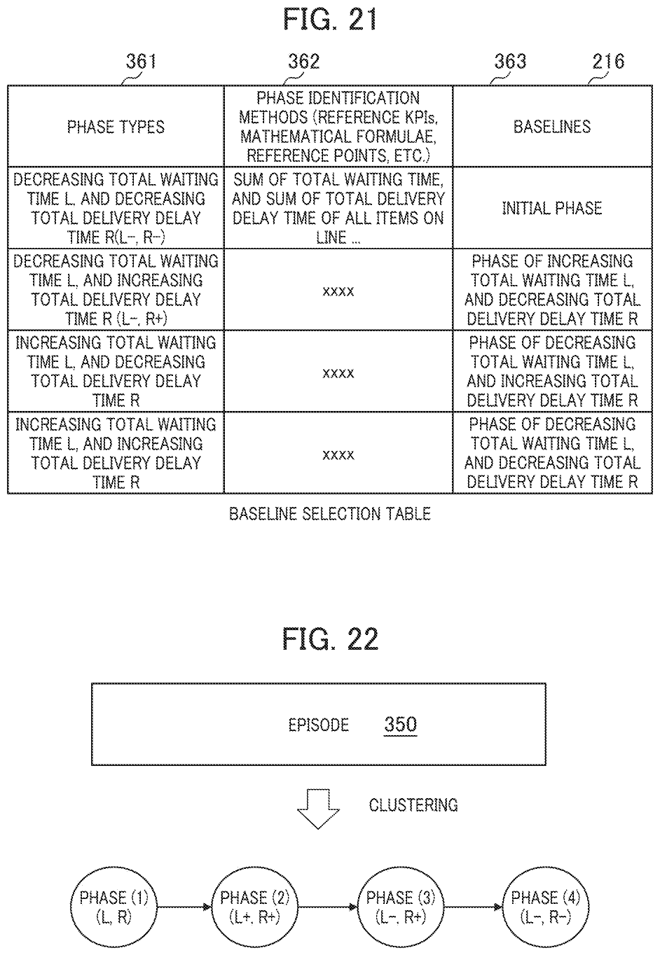

FIG. 21 illustrates an example of the baseline selection table 216 in the example of the item supply-order control explained with reference to FIG. 19. As mentioned above, the baseline selecting section 212 generates the baseline selection table 216 illustrated in FIG. 21 on the basis of the user input data 215 illustrated in FIG. 20. In the example illustrated in FIG. 21, the fields of phase types 361 indicate four phases.

At the phase (L−, R−), the total waiting time L decreases, and the total delivery delay time R decreases. At the phase (L−, R+), the total waiting time L decreases, and the total delivery delay time R increases. At the phase (L+, R−), the total waiting time L increases, and the total delivery delay time R decreases. At the phase (L+, R+), the total waiting time L increases, and the total delivery delay time R increases. The phases correspond to the situations in the user input data 215.

The fields of phase identification methods 362 indicate the total waiting time L, and the total delivery delay time R as KPIs to be used for identifying phases of the phase type 361. In the present example, two KPIs are used for dividing an episode into phases, and these match user-specified KPIs. The fields of baselines 363 specify predetermined phases as baselines of phases. In computation of degrees of contribution, the average value of input features in baseline phases are used, for example.

Combinations of phase identification methods, and baselines are associated in advance with phase types. The association may be defined for each type of KPIs, and a common association definition may be applied to a plurality of KPIs. For example, combinations of phase types, phase identification methods, and baselines are defined for KPIs. The baseline selection table 216 may be associated in advance with a user-input KPI, and an input of situations, and actions may be omitted.

In accordance with the baseline selection table 216 illustrated in FIG. 21, the clustering section 211 forms a plurality of phases in the episode. The tendency of changes of the total waiting time L, and the total delivery delay time R can be decided on the basis of the values of the total waiting time L, and the total delivery delay time R at consecutive steps. By analyzing changes of the total waiting time L, and the total delivery delay time R in an episode in accordance with a predetermined rule, the clustering section 211 can decide steps forming phases in the episode, and the types of the phases.

FIG. 22 illustrates an example in which the clustering section 211 forms a plurality of phases in an episode in accordance with the baseline selection table 216 illustrated in FIG. 21. The clustering section 211 decides phases on the basis of the total waiting time L, and the total delivery delay time R. Four phases are formed in the example illustrated in FIG. 22. They are the initial phase, the phase (L+, R+), the phase (L−, R+), and the phase (L−, R−). The phases transition in this order. In the example illustrated in FIG. 22, three of the four phases indicated by the baseline selection table 216 are applied.

The degree-of-contribution calculating section 213 acquires, from an episode, input reference data of a baseline preset for the initial phase, and baselines corresponding to the phases indicated by the baseline selection table 216. The input reference data of the initial phase is the average value of input features at the initial phase, for example. The degree-of-contribution calculating section 213 calculates degrees of contribution of the input features (state elements) at the steps.

On the basis of degree of contribution of each phase in the episode, the explanation generating section 214 generates explanatory data 220 of the policy model 201. In order to explain a basis of the policy model, the explanation generating section 214 may create an image including various graphs and sentences like the one explained with reference to FIG. 17, or may generate a saliency video like the one explained with reference to FIG. 18.

Note that the present invention is not limited to the embodiments described above, but includes various modification examples. For example, the embodiments described above are explained in detail in order to explain the present invention in an easy-to-understand manner, and embodiments of the present invention are not necessarily limited to the ones including all the configurations that are explained. In addition, some of the configurations of an embodiment can be replaced with configurations of another embodiment, and also configurations of an embodiment can be added to the configurations of another embodiment. In addition, some of the configurations of each embodiment can additionally have other configurations, can be removed, or can be replaced with other configurations.

In addition, the configurations, functions, processing sections, and the like described above may partially, or entirely be realized by hardware by designing them in an integrated circuit, or by other means, for example. In addition, the configurations, functions, and the like described above may be realized by software by a processor interpreting and executing programs that realize the functions. Information such as programs, tables or files that realize the functions can be placed in a recording device such as a memory, a hard disk or a SSD (Solid State Drive), or in a recording medium such as an IC card or an SD card.

In addition, control lines, and information lines that are considered as being necessary for explanation are illustrated, and all the control lines, and information lines that are necessary for realizing products are not necessarily illustrated. Actually, it may be considered that almost all the configurations are interconnected.

What is claimed is:

1. A computer system that generates an explanation of a basis of a machine learning model, the computer system comprising:
one or more processors; and
one or more storage devices that store a program to be executed by the one or more processors, wherein
the machine learning model estimates an appropriate output in an environment with a changing state, and
the one or more processors
acquire an episode, the episode including steps at different times, each step in the steps indicating a state of the environment, and an output selected by the machine learning model in the state;
form a plurality of phases including one or more consecutive steps on a basis of one or more changing indicators in the episode; and
generate data that explains a basis of the machine learning model in the plurality of phases.

2. The computer system according to claim 1, wherein the one or more processors decide a reference point for explaining a basis of the machine learning model for each of the plurality of phases, and generate data that explains the basis of the machine learning model on a basis of the reference point.

3. The computer system according to claim 2, wherein the one or more processors decide the one or more indicators in accordance with a user input.

4. The computer system according to claim 3, wherein, in accordance with the user input, the one or more processors generate information indicating phase types to be applied to the episode, methods for identifying the phase types, and a reference point for each of the phase types.

5. The computer system according to claim 1, further comprising an output device, wherein
the output device displays a saliency video that explains a basis of the machine learning model.

6. The computer system according to claim 1, further comprising an output device, wherein
the output device displays a state transition diagram of phase changes that explains a basis of the machine learning model.

7. A method of generating an explanation of a basis of a machine learning model, the method comprising:
estimating, by the machine learning model, an appropriate output in an environment with a changing state;
acquiring an episode by one or more processors, the episode including steps at different times, each step in the steps indicating a state of the environment, and an output selected by the machine learning model in the state;
forming, by the one or more processor, a plurality of phases including one or more consecutive steps on a basis of one or more changing indicators in the episode; and
generating, by the one or more processors, data that explains a basis of the machine learning model in the plurality of phases.

8. The method according to claim 7, comprising deciding a reference point for explaining a basis of the machine learning model for each of the plurality of phases, and generating data that explains the basis of the machine learning model on a basis of the reference point.

9. The method according to claim 8, comprising deciding the one or more indicators in accordance with a user input.

10. The method according to claim 9, comprising generating, in accordance with the user input, information indicating phase types to be applied to the episode, methods for identifying the phase types, and a reference point for each of the phase types.

11. The method according to claim 7, comprising displaying a saliency video that explains a basis of the machine learning model.

12. The method according to claim 7 comprising displaying a state transition diagram of phase changes that explains a basis of the machine learning model.
